(19) United States
(12) Patent Application Publication
(10) Pub. No.: US 2011/0300768 A1
(43) Pub. Date: Dec. 8, 2011

(54) ETHYLENE ADSORBENT PACKAGING OR BARRIER MATERIAL AND METHOD OF MAKING THE SAME

(75) Inventors: Krishnamurthy Gurudatt, Bangalore (IN); Tarun Jagga, Mumbai (IN); Arun Pal Aneja, Digvijaygram (IN); Anup Kumar Rakshit, Mumbai (IN)

(73) Assignee: Reliance Industries Limited

(21) Appl. No.: 13/202,156

(22) PCT Filed: Feb. 17, 2010
(86) PCT No.: PCT/IN2010/000089

§ 371 Date: Aug. 18, 2011

(30) Foreign Application Priority Data
Feb. 20, 2009 (IN) 384/MUM/2009

(51) Int. Cl. B32B 5/02; B05D 7/00; B29C 67/00; B05D 3/00; B05D 5/00; B32B 27/02; B05D 3/02

(52) U.S. Cl. 442/152; 442/59; 442/167; 427/372.2; 427/389.9; 264/137

(57) ABSTRACT

An ethylene adsorbent packaging or barrier material and method of making the same. The package or barrier comprises a textile substrate impregnated with a solution of zeolite, cross-linker and binder. The method of making the ethylene adsorbent packaging or barrier material comprises impregnating a textile substrate with a solution of zeolite powder with crosslinker and binder in a solvent at a PH of 5.0 to 7.0 adjusted with an organic acid followed by removing the excess solution from the substrate and drying and curing the substrate at 50-250° C. If desired the substrate is formed to the desired shape. The packaging can be used for packing ethylene susceptible and perishable articles. The barrier material can be used as a barrier or as a separator for ethylene gas.

### CROSS-REFERENCE TO RELATED APPLICATION

This application claims priority, under 35 U.S.C. §371(c), to International Application No. PCT/IN2010/000089, filed on Feb. 17, 2010, the disclosure of which is incorporated herein by reference in its entirety.

### FIELD OF THE INVENTION

This invention relates to an ethylene adsorbent packaging or barrier material and method of making the same.

### BACKGROUND OF THE INVENTION

Deterioration or spoilage of ethylene susceptible and perishable articles like food articles like vegetables and fruits starts from the time they are harvested and gives rise to undesirable changes in the physical and chemical properties and characteristics of such articles. Due to deterioration or spoilage, the food articles start rotting and are deprived of their good and effective or nutritious qualities and values and will have to be ultimately disposed of as garbage. Ripening is a process in fruits that causes most of the fruits to become sweeter, less green and softer and more edible. An organic compound involved with ripening is ethylene, a gas created by plants from the amino acid methionine. Ethylene increases the intracellular levels of enzymes like Amylase in fruits and freshly cut fruits which hydrolyzes starch to produce simple sugars and pectinase, which in turn hydrolyzes pectin, a substance that keeps fruits hard. Continued and uncontrolled biochemical activity subsequent to ripening leads to rotting of fruits and vegetables and render them unfit for consumption. Therefore, prevention of deterioration or spoilage of fruits and vegetables by preservation aimed at increasing their shelf life is of paramount importance for their use in times of scarcity or non-availability or for transporting them to distant places where they are not normally available.

One method used in earlier times to preserve and improve storage life of ethylene susceptible and perishable articles like food items like fruits and vegetables comprises spraying of antibacterial and antifungal chemical agents like silver nitrate, sorbic acid anhydride, chlorinated hydrocarbon or potassium permanganate on the fruits and vegetables (Active packaging for food applications, A L Brody et al, 2001, CRC press, London). Spraying with antibacterial and antifungal agents leaves traces thereof on the fruits and vegetables, which will have serious health hazards on the consumers. WO02/069723A2 describes a package for prolonging the storage life of produce. The package comprises a gas permeable container and an atmosphere modifying device contained within the container. Produce is stored in the container containing the device. The device comprises a carbon dioxide emitter, an oxygen scavenger and an optional ethylene scavenger. The ethylene scavenger includes CaO₂, modified aluminia, zeolite, zeolite impregnated with permanganate, activated carbon and combinations thereof. The ethylene scavenger modifies the atmosphere in the container by removing ethylene by chemical reaction or by physical absorption or adsorption. The package is suitable to use in a consumer's home, for example in the kitchen cabinet or refrigerator. The package comprises a large number of components and is expensive besides being complicated in construction. In case it is used in a refrigerator its use becomes energy intensive and further uneconomical. Patent application No 1635/DEL/2005A relates to a refrigerator system to extend storage life of perishable food items. The refrigerator system includes a preserving device comprising a hollow retainer provided with perforations or serrations and a hinged door and a first tyvek pouch containing zeolite and/or activated carbon coated with potassium permanganate fixed inside the retainer. The zeolite and/or activated carbon is additionally impregnated with a fragrance. Optionally the device includes a second tyvek pouch containing activated carbon placed inside the retainer. The refrigeration system requires energy for its operation and is uneconomical. Further the refrigeration system comprises a large number of components and is expensive besides being complicated with construction.

JP 1031838A relates to a transparent film for keeping freshness. The film comprises polyolefin and a zeolite type inorganic porous absorbent containing specific amounts of silicon and aluminium oxides. The film is made by compounding ie melt mixing polyolefin, for example low density polyethylene to with zeolite in the molar ratio 3:15, preferably 5:10. Because of the melt mixing, making of the film is energy intensive and uneconomical. Besides, zeolite gets embedded in the bulk of polymer during melt mixing. As a result, the amount of zeolite on the surface of the film is reduced correspondingly reducing the ethylene adsorption efficiency of the film. JP 2006112017A relates to a wrapping bag comprising cloth as a supporting material. The cloth is loaded with a titanium oxide based photocatalyst and a ceramic material having antimold or anti-bacterial function even under an environment without light. It is essentially used as a wrapping bag during the growth of fruits and vegetables and for suppressing/preventing the putrefaction and trauma through maturation, preservation and distribution after the harvest. Photocatalytic activity of these catalysts under different conditions would be different and result in inconsistent performance. Besides TiO₂ based photocatalyst and ceramic catalyst are also expensive. US 2004156918A1 relates to antimicrobial packaging materials and methods for making the same. Zeolite containing dispersions are used to print the packaging materials and render them anti-microbial. After drying onto the packaging materials, the zeolite releases antimicrobial metal ions such as silver ions on exposure to moisture. The teaching in this patent is essentially to render the packing material antimicrobial. As the zeolite containing dispersions are applied on the packaging material by printing, presence of zeolite on the packaging material is localized and concentrated in isolated regions correspondingly reducing the microbial activity of the packaging material.

### OBJECTS OF THE INVENTION

An object of the invention is to provide an ethylene adsorbent packaging for ethylene susceptible and perishable articles, which packaging is soft and has excellent mechanical properties and air permeability and which packaging enhances the shelf life of the articles at ambient conditions so as to be energy saving and cost effective.

Another object of the invention is to provide an ethylene adsorbent packaging for ethylene susceptible and perishable articles, which packaging is washable and reusable.

Another object of the invention is to provide an ethylene adsorbent packaging for ethylene susceptible and perishable articles, which packaging is simple in construction and user friendly.

Another object of the invention is to provide a method of making an ethylene adsorbent packaging for ethylene susceptible and perishable articles, which packaging is soft and has excellent mechanical properties and air permeability and which packaging enhances the shelf life of the articles at ambient conditions so as to be energy saving and cost effective.

Another object of the invention is to provide a method of making an ethylene adsorbent packaging for ethylene susceptible and perishable articles, which packaging is washable and reusable.

Another object of the invention is to provide a method of making an ethylene adsorbent packaging for ethylene susceptible and perishable articles, which packaging is simple in construction and user friendly.

Another object of invention is to provide an ethylene adsorbent barrier material which is soft and has excellent mechanical properties and air permeability and which can be used at ambient conditions so as to be energy saving and cost effective.

Another object of the invention is to provide an ethylene adsorbent barrier material which is washable and reusable.

Another object of the invention is to provide an ethylene adsorbent barrier material which is simple in construction and is user friendly.

Another object of invention is to provide a method of making an ethylene adsorbent barrier material which is soft and has excellent mechanical properties and air permeability and which can be used at ambient conditions so as to be energy saving and cost effective.

Another object of the invention is to provide a method of making an ethylene adsorbent barrier material which is washable and reusable.

Another object of invention is to provide a method of making an ethylene adsorbent barrier material which is simple in construction and is user friendly.

### DETAILED DESCRIPTION OF THE INVENTION

According to the invention there is provided an ethylene adsorbent packaging for ethylene susceptible and perishable articles, the packaging comprising a textile substrate impregnated with a solution of zeolite, cross linker and binder.

According to the invention there is also provided a method of making an ethylene adsorbent packaging for ethylene susceptible and perishable articles, the method comprising impregnating a textile substrate with a solution of zeolite powder with crosslinker and binder a solvent at a PH of 5.0 to 7.0 adjusted with an organic acid followed by removing the excess solution from the substrate and drying and curing the substrate at 50-250° C. and if desired forming the substrate to the desired shape.

According to the invention there is also provided an ethylene adsorbent barrier material comprising a textile substrate impregnated with solution of zeolite, cross linker and binder.

According to the invention there is also provided a method of making an ethylene adsorbent barrier material, the method comprising impregnating a textile substrate with a solution of zeolite powder with crosslinker and binder in a solvent at a PH of 5.0 to 7.0 adjusted with an organic acid followed by removing the excess solution from the substrate and drying and curing the substrate at 50-250° C. and if desired forming the substrate to the desired shape.

The binder is either present in the textile substrate or separately added at the time of zeolite impregnation. Preferably the textile substrate is impregnated with a solution of zeolite of micron sizes of 1 to 10μ, pore diameter 2-10 A and pore volume 0.1 to 1.0 to a loading of 0.5 to 15% of the weight of the textile substrate, cross linker melamine formaldehyde in 1 to 10% by weight of the zeolite and binder acrylic polymer or copolymer in 5-25% be weight of the zeolite. Still preferably, the textile substrate is impregnated with a solution of zeolite of micron sizes of 2 to 6μ, pore diameter 3-5A and pore volume 0.2 to 0.5 ml/g to a loading of 1-10% of the weight of the textile substrate, cross linker melamine formaldehyde in 1-10% by weight of the zeolite and binder acrylic polymer or copolymer in 5-25% by weight of the zeolite. The zeolite may be of class 3A, 4A, 5A, ZSM, X or Y of Sodium Aluminosilicate (Kirk-Othmer Encyclopedia of Chemical Technology, 5^{th} ed Vol 16, John Wiley and sons Inc, NJ, P 811 to 853) and may be ionized for instance with Ag or Zn ions so as to impart antibacterial/antifungal activity to the substrate or with NH4 ions to bring about polarity changes in the substrate. Because of polarity changes, the substrate can disperse better. The solution may include pigments or colourants in 0.1 to 1% by weight of the zeolite. The pigments or colourants include those listed in the IS: 9833 like 2:4 Dinitroanilene-2-naphthol, Phthalocyanine or Ferrous complex of alpha-nitoso-beta-naphthol. The textile substrate may comprise woven, non-woven or knitted textile substrate made with polyester fibres or blends thereof with viscose, cotton or acrylic fibres. The solvent is water or a mixture of water with an organic solvent like isopropyl alcohol. The organic acid is selected from acetic acid, formic acid or phosphoric acid. Preferably the pH of the solution is adjusted to 5.5 to 6.0 and the drying and curing of the substrate is carried out 110-190° C. The impregnation may be carried during or after making of the substrate. In order to use the zeolite impregnated or modified substrate as a packaging it may be optionally and if desired, formed into the required shape like bag, box, cover or the like. It can also be used as sheet or film to wrap around the perishable articles. It can also be used as a liner inside or outside the packaging or on a support member. In order to use the zeolite treated or modified substrate as a barrier material it may be optionally and if desired formed into the required shapes or used as a separator membrane or film optionally supported on a stand. According to the invention because of the impregnation of the textile substrate with zeolite in the presence of cross linker and binder the textile substrate is modified so as to distribute the zeolite ions on the entire surface area of the substrate and improve ethylene adsorption over the entire surface area of the substrate. The ethylene adsorbent packaging or barrier material of the invention has optimum levels of softness, mechanical properties and air permeability and low extraction levels of zeolite during washing. Therefore, it is also washable and reusable. The packaging can be advantageously used to enhance the shelf life of ethylene susceptible and perishable articles at ambient conditions and is therefore, energy saving and cost effective. The barrier material can be advantageously used as a barrier or as a separator for ethylene gas at ambient conditions in an energy saving and cost effective manner. Besides being cost effective and energy saving, both the ethylene adsorbent packaging or barrier material are also simple in construction and user friendly.

The following experimental examples are illustrative of the invention but not limitative of the scope thereof.

### Example 1

(a) Strips (1 m²) of non-woven textile substrate made with polyester by hydro entanglement route were impregnated with an aqueous solution containing zeolite (class 4A) of micron size 5μ, pore diameter of 4 A, and pore volume 0.3 ml/g from M/s Zeotec Adsorbents, New Delhi (16 gpl), acrylic polymer binder Pidysyn 3640 H from M/s Pidilite Industries Ltd, Mumbai (30 gpl) and melamine formaldehyde cross linker pidifix 361 M from Pidilite Industries Ltd, Mumbai (3 gpl). The solution was prepared under continuous stirring and pH of the solution was adjusted to 6.0 by the addition of acetic acid. The impregnated strips were passed between a pair of rotating squeeze rollers to remove excess solution. The strips were fixed on stenter frames and passed through a hot air chamber at 150° C. for 90 secs. Dried and cured strips were evaluated for various mechanical and performance properties as against non-impregnated strips and the results were as shown in the following Table 1.

TABLE 1

| | | | | | Air permeability | | Ethylene | |
|---|---|---|---|---|---|---|---|---|
| | | | Ash | | cc/cm/sec (2 | CS2 | adsorption | Extraction |
| | Weight | Thickness | (Zeolite) | Strength* | layers) at 12.5 mm | adsorption | (mmol/g | in water |
| Substrate | gm/cm² | (mm) | content % | (Nper5 cms) | head of water | % | at 2 mm Hg) | (mg/in) |
| Non- | 78.0 | 0.55 | 0.10 | MD-197.7 | 113.0 | 0.13 | 0.0005 | 0.02 |
| impregnated | | | | CD-89.6 | | | | |
| Impregnated | 95.9 | 0.58 | 4.4 | MD-207.5 | 87.5 | 2.07 | 0.0080 | 0.56 |
| | | | | CD-91.1 | | | | |
| Impregnated | 91.8 | 0.57 | 3.8 | MD-201.7 | 86.1 | 2.11 | 0.0070 | 0.48 |
| and after water | | | | CD-87.5 | | | | |
| washing and | | | | | | | | |
| drying 5 times | | | | | | | | |

MD—Machine direction, CD—Cross direction

It is observed from the Table 1 that high CS₂ and ethylene adsorption was imparted to the textile substrate after the zeolite treatment. It is also observed from the Table 1 that the mechanical properties of the substrate were retained significantly vis a vis the untreated substrate. It is also observed from the Table 1 that air permeability of the treated substrate was also retained within limits. Further it is observed that after washing the retention of adsorption properties were very good, indicating reusability of the product. The extraction value of 0.60 for the treated sample was above the BIS 12252 specified limit of 0.65 mg/in².

(b) Fruits and vegetables were covered in the modified textile substrate and were stored in uncontrolled atmosphere, where temperature varied from 20° C. to 30° C. and relative humidity from 55 to 70%. Mangoes covered with the modified textile substrate were found to soften and blacken only after 8 days, while mangoes kept in a polythene bag for comparison under the same atmospheric conditions, started softening and blackening in just 3 days. This indicated extension of shelf life by 5 days for fruits covered with the zeolite modified textile substrates. Similar experiments with other fruits and vegetables covered with the treated substrates showed shelf life extension as pomegranate-6 days, lemons-7 days, tomatoes-3 days and oranges-4 days.

### Example 2

(a) A consolidated web made from layers of web made with polyester fibre using an 20 opener and set of carding machines was passed through an aqueous solution containing zeolite (class 4A) of micron size 5μ, pore diameter of 4 A, and pore volume 0.3 ml/g from M/s Zeotec Adsorbents, New Delhi (16 gpl), acrylic polymer binder of Vam emulsion NW1 2076 from Vam Organics, Mumbai (30 gpl) and melamine formaldehyde cross linker pidifix 361 M from Pidilite Industries Ltd, Mumbai (3 gpl). The solution was prepared under continuous stirring and pH of the solution was adjusted to 6.0 by the addition of acetic acid. Excess solution in the web was pressed out by passing the web between a pair of squeeze rollers. The web was then passed through heated cylinders at 150° C. for 90 secs and wound on rollers in a continuous fashion. The modified non-woven substrate was evaluated for various mechanical and performance properties against web impregnated with an aqueous solution containing 16 gpl of the above binder and the test results were as shown in the following Table 2.

TABLE 2

| | | | | | Air | | Ethylene | |
|---|---|---|---|---|---|---|---|---|
| | | | Ash | | permeability | CS2 | adsorption | Extraction |
| Textile | Weight | Thickness | (Zeolite) | Strength | Cc/cm/sec | adsorption | (mmol/g | in water |
| substrate | gm/cm | (mm) | content % | (Nper-5 cms) | (2 layers) | % | at 2 mm Hg) | (mg/in ) |
| Treated only | 68.7 | 0.38 | 0.7 | MD-313.9 | 77.8 | 0.81 | 0.0005 | — |
| with the binder | | | | CD-40.2 | | | | |
| Treated with the | 76.7 | 0.47 | 8.5 | MD-143.6 | 109.7 | 3.28 | 0.0025 | 0.60 |
| solution of Example 2a | | | | CD-17.5 | | | | |
| Treated with the | 72.3 | 0.43 | 7.6 | MD-135.6 | 109.7 | 3.13 | 0.0017 | 0.32 |
| solution of Example 2a | | | | CD-14.3 | | | | |
| and after washing | | | | | | | | |
| and drying 5 times | | | | | | | | |

It is observed from the Table 2 that high CS₂ and Ethylene adsorption was imparted to the textile substrate after the zeolite treatment. It is also observed from the Table 2 that the air permeability of the substrate improved with the zeolite treatment and that mechanical and permeability properties of the zeolite treated substrate were retained significantly vis a vis the 5 sample treated only with the binder. The extraction value of 0.60 for the zeolite treated sample was within the BIS 12252 specified limit of 0.65 mg/in². It is also observed from the Table 2 that after washing, the retention of adsorption properties of the zeolite treated substrate were very good, indicating reusability of the product. It is also clear from the Table 2 that the binder treatment alone did not impart the desired properties to the textile substrate.

(b) Tomatoes were covered with the zeolite modified textile substrate and were found to soften and break only after 7 days, when kept in an uncontrolled atmosphere, where temperature varied from 20° C. to 30° C. and relative humidity from 55 to 70%. As against this, tomatoes kept in a polythene bag for comparison under the same atmospheric conditions started softening and breaking in just 3 days. This indicated a shelf life extension of 4 days for tomatoes covered with the zeolite modified textile substrate. Similar experiments with other fruits and vegetables covered with the zeolite modified substrate showed shelf life extension as ivy gourd—4 days, lemons—7 days, ladies finger—5 days and Indian beans—6 days.

1. An ethylene adsorbent packaging for ethylene susceptible and perishable articles, the packaging comprising a textile substrate impregnated with a solution of zeolite, cross-linker and binder.

2. The ethylene adsorbent packaging as claimed in claim 1, wherein the textile substrate is impregnated with a solution of zeolite of micron sizes of 1 to 10μ, pore diameter 2-10 A and pore volume 0.1 to 1.0 ml/g to a loading of 0.5 to 15% of the weight of the textile substrate, cross linker melamine formaldehyde comprising 1 to 10% by weight of the zeolite and binder acrylic polymer or copolymer comprising 5-25% by weight of the zeolite.

3. The ethylene adsorbent packaging as claimed in claim 1, wherein the textile substrate is impregnated with a solution of zeolite of micron sizes of 2 to 6μ, pore diameter 3-5A and pore volume 0.2 to 0.5 ml/g to a loading of 1-10% of the weight of the textile substrate, cross linker melamine formaldehyde in 1-10% by weight of the zeolite and binder acrylic polymer or copolymer in 5-25% by weight of the zeolite.

4. The ethylene adsorbent packaging as claimed in claim 1, wherein the zeolite is ionized zeolite.

5. The ethylene adsorbent packaging as claimed in claim 1, wherein the solution includes pigments or colourants in 0.1 to 1% by weight of the zeolite.

6. The ethylene adsorbent packaging as claimed in claim 1, wherein the textile substrate comprises woven, non-woven or knitted textile substrate made with polyester fibres or blends thereof with viscose, cotton or acrylic fibres.

7. A method of making an ethylene adsorbent packaging for ethylene susceptible and perishable articles, the method comprising impregnating a textile substrate with a solution of zeolite powder with crosslinker and binder in a solvent at a PH of 5.0 to 7.0 adjusted with an organic acid followed by removing the excess solution from the substrate and drying and curing the substrate at 50-250° C. and if desired forming the substrate to the desired shape.

8. The method as claimed in claim 7, wherein the solution comprises zeolite of micron sizes of 1 to 10μ, pore diameter 2-10 A and pore volume 0.1 to 1.0 ml/g to a loading of 0.5 to 15% of the weight of the textile substrate, cross linker melamine formaldehyde in 1 to 10% by weight of the zeolite and binder acrylic polymer or copolymer in 5-25% by weight of the zeolite.

9. The method as claimed in claim 7, wherein the solution comprises zeolite of micron sizes of 2 to 6μ, pore diameter 3-5A and pore volume 0.2 to 0.5 ml/g to a loading of 1-10% of the weight of the textile substrate, cross linker melamine formaldehyde in 1-10% by weight of the zeolite and binder acrylic polymer or copolymer in 5-25% by weight of the zeolite.

10. The method as claimed in claim 7, wherein the zeolite is ionized zeolite.

11. The method as claimed in claim 7, wherein the solution includes pigments or colourants in 0.1 to 1% by weight of the zeolite.

12. The method as claimed in claim 7, wherein the textile substrate comprises woven, non-woven or knitted textile substrate made with polyester fibres or blends thereof with viscose, cotton or acrylic fibres.

13. The method as claimed in claim 7, wherein the solvent is water or a mixture of water with an organic solvent like isopropyl alcohol.

14. The method as claimed in claim 7, wherein the pH of the solution is adjusted to 5.5 to 6.0 with an organic acid selected from acetic acid, formic acid, phosphoric acid, etc.

15. The method as claimed in claim 7, wherein the drying and curing of the substrate is carried out at 110-190° C.

16. The method as claimed in claim 7, wherein the impregnation is carried out during or after making of the substrate.

17. An ethylene adsorbent barrier material comprising a textile substrate impregnated with solution of zeolite, cross linker and binder.

18. The ethylene adsorbent barrier material as claimed in claim 17, wherein the solution comprises zeolite of micron sizes of 1 to 10μ, pore diameter 2-10 A and pore volume 0.1 to 1.0 ml/g to a loading of 0.5 to 15% of the weight of the textile substrate, cross linker melamine formaldehyde in 1 to 10% by weight of the zeolite and binder acrylic polymer or copolymer in 5-25% be weight of the zeolite.

19. The ethylene adsorbent barrier material as claimed in claim 17, wherein the solution comprises zeolite of micron sizes of 2 to 6μ, pore diameter 3-5A and pore volume 0.2 to 0.5 ml/g to a loading of 1-10% of the weight of the textile substrate, cross linker melamine formaldehyde in 1-10% by weight of the zeolite and binder acrylic polymer or copolymer in 5-25% by weight of the zeolite.

20. The ethylene adsorbent barrier material as claimed in claim 17, wherein the zeolite is ionized zeolite.

21. The ethylene adsorbent barrier material as claimed in claim 17, wherein the solution includes pigments or colourants in 0.1 to 1% by weight of the zeolite.

22. The ethylene adsorbent barrier material as claimed in claim 17, wherein the textile substrate comprises woven, non-woven or knitted textile substrate made with polyester fibres or blends thereof with viscose, cotton or acrylic fibres.

23. A method of making an ethylene adsorbent barrier material, the method comprising impregnating a textile substrate with a solution of zeolite powder with crosslinker and binder in a solvent at a PH of 5.0 to 7.0 adjusted with an organic acid followed by removing the excess solution from the substrate and drying and curing the substrate at 50-250° C. and if desired forming the substrate to the desired shape.

24. The method as claimed in claim 23, wherein the solution comprises zeolite of micron sizes of 1 to 10μ, pore diameter 2-10 A and pore volume 0.1 to 1.0 ml/g to a loading of 0.5 to 15% of the weight of the textile substrate, cross linker melamine formaldehyde in 1 to 10% by weight of the zeolite and binder acrylic polymer or copolymer in 5-25% by weight of the zeolite.

25. The method as claimed in claim 23, wherein the solution comprises zeolite of micron sizes of 2 to 6μ, pore diameter 3-5A and pore volume 0.2 to 0.5 ml/g to a loading of 1-10% of the weight of the textile substrate, cross linker melamine formaldehyde in 1-10% by weight of the zeolite and binder acrylic polymer or copolymer in 5-25% by weight of the zeolite.

26. The method as claimed in claim 23, wherein the zeolite is ionized zeolite.

27. The method as claimed in claim 23, wherein the solution includes pigments or colourants in 0.1 to 1% by weight of the zeolite.

28. The method as claimed in claim 23, wherein the textile substrate comprises woven, non-woven or knitted textile substrate made with polyester fibres or blends thereof with viscose, cotton or acrylic fibres.

29. The method as claimed in claim 23, wherein the solvent is water or a mixture of water with an organic solvent like isopropyl alcohol.

30. The method as claimed in claim 23, wherein the pH of the solution is adjusted to 5.5 to 6.0 with an organic acid selected from acetic acid, formic acid, phosphoric acid, etc.

31. The method as claimed in claim 23, wherein the drying and curing of the substrate is carried out at 110-190° C.

32. The method as claimed in claim 23, wherein the impregnation is carried out during or after making of the substrate.
